(19) United States
(12) Patent Application Publication
(10) Pub. No.: US 2009/0292464 A1
(43) Pub. Date: Nov. 26, 2009

(54) SYSTEM AND METHOD FOR PROVIDING GEOGRAPHIC MARKERS ON ELECTRONIC OBJECTS AND REAL-WORLD OBJECTS

(75) Inventors: Gil Fuchs, Woodside, CA (US); Simon D. Glassmann, Mill Hill (GB); David Nevin, San Rafael, CA (US); Darren Koenig, Charlotte, NC (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 12/126,743

(22) Filed: May 23, 2008

(51) Int. Cl. G01C 21/00

(52) U.S. Cl. 701/208; 701/207

(57) ABSTRACT

A system and method for attaching geographical markers to a variety of objects, including real-world objects, electronic documents, people, software applications, and other items of information, including stationary and moving entities. In accordance with an embodiment, the system provides an object location identifier (OLI), and can use additional forms of identifiers such as universal location referencing objects (ULRO) for mapping real-world objects, electronic documents, people, software applications, and other items of information. The object location identifier answers the questions of who and where a particular object may be. A mobile object location identifier (MOLI) feature can also be provided as a standardized way for specifying an object location identifier for user with mobile entities, including people, websites, and wireless applications. A mobile uniform resource locator (MURL) feature can also be provided as a way for sharing and using object location identifier, and particularly for allowing mobile entities to control and share location information using a consumer-friendly URL-like nomenclature.

### CROSS REFERENCE TO RELATED APPLICATIONS

This application is related to co-pending U.S. patent applications “SYSTEM AND METHOD FOR CREATING UNIVERSAL LOCATION REFERENCING OBJECTS”, application Ser. No. 11/271,436, filed Nov. 10, 2005; and “SYSTEM AND METHOD FOR PROVIDING A VIRTUAL DATABASE ENVIRONMENT AND GENERATING DIGITAL MAP INFORMATION”, application Ser. No. 11/742,937, filed May 1, 2007; each of which applications are herein incorporated by reference.

### FIELD OF THE INVENTION

The invention is generally related to electronic maps, and, specifically to a system and method for attaching geographical markers to real-world objects, electronic objects, people, and any other stationary or moving entity.

### BACKGROUND

The use of digital geographic or map data has become commonplace in modern society. Commonly referred to as “electronic maps” or “digital maps”, the map data is already used in a wide variety of applications. A typical application is within the travel industry, where digital maps are used to research travel destinations, resort facilities, and alternate routes. Internet-based business-to-consumer companies often use digital maps to direct customers to theaters, stores, restaurants, and other commercial businesses. Digital maps are also often used in industrial settings, for example, to calculate routes for delivery drivers, or to provide directions for emergency and medical crews to follow when responding to emergency calls.

Increasingly, digital map providers have switched from a process of merely digitizing paper-based maps, and are now more appropriately seen as gatherers and organizers of an ever greater variety of data, covering topics such as street addresses, transportation networks, water bodies, parklands political districts, census data, demographic information, commercial businesses, and entertainment facilities, for the purpose of supporting the latest applications. At the same time, the variety of uses for this map data has also expanded to include such applications as in-car driving assistance; personal digital assistant (PDA) and cell phone-based navigation; and locally-focused news, media, and yellow-page information services. With this increase in utility it has become evident that many of these software applications need to combine the underlying map data with other sources of location-related information to provide a more useful end-product.

Digital maps have been supplemented by map databases, map documents, and map data in a variety of digital, electronic formats, capable of being updated as desired and able to respond to a selected range and type of operator input and to produce operator-requested output. Many electronic documents and electronic databases in common usage today comprise information related to geographic location(s). Indeed, it is not easy to think of a class of electronic documents or a class of electronic databases that does not at least occasionally incorporate some form of geographically related information. Today, maps have evolved well beyond their centuries-old status as static paper depictions of a non-adjustable data set as recorded at one particular time. Digital maps can allow for regular modification of data points included in the map, in addition to active operator selection of (a) desired geographic features of interest, and (b) how much, and which additional information to present. As new types of information arise, the whole map can be quickly updated to reflect changes or corrections to all or just a small subset of locations.

Some digital maps allow for linking between a text address and its location on the map. This has been generally referred to as “geocoding”. For example, if an operator inputs a street address into an Internet-based map application then the output indicates the location of that particular address on a map that is drawn of the surrounding area, i.e. it is geocoded. Essentially a map of the region encompassing the address of interest is constructed around the selected point. The map may contain overlays of useful information. For example, a street map of San Francisco may be overlaid with a map of the railroad system in San Francisco and that map in turn overlaid by icons representing San Francisco restaurants and parking facilities.

However, these various overlays are still “map-level overlays”, meaning that they are registered one to another on the basis of their coordinates. No interactivity is typically available between different points in the overlay or between a point in one overlay and a point in another overlay. While such a coordinate overlay may result in something that appears to an end-user like a single map, it cannot dynamically function like one fully integrated, intelligent digital map. In a sense, the entities in one layer know nothing about the entities in any other layer and hence cannot support further data processing related to useful linkages between those entities.

Furthermore, in a traditional map, only “real” or physical locations and objects such as cities, parks, and buildings are mapped and displayed. This reduces the flexibility of the map to take account future applications, or to provide support for new types of map items. As new applications are developed, the limitations of current digital map offerings become more apparent. For example, today there is no simple way for users of mobile and web-based applications, that potentially use both digital map data and external location parameters, to control and exchange information about their location. While the market is always growing for wireless location-based applications and services on mainstream mobile devices, there is currently little or no support within the digital maps themselves for such applications.

### SUMMARY

Described herein is a system and method for attaching geographical markers to a variety of objects, including real-world objects, electronic documents, people, software applications, and other items of information, including stationary and moving entities. In accordance with an embodiment, the system provides an object location identifier (OLI), and can use additional forms of identifiers such as universal location referencing objects (ULRO) for mapping real-world objects, electronic documents, people, software applications, and other items of information. The object location identifier answers the questions of who and where a particular object may be.

In accordance with an embodiment, a mobile object location identifier (MOLI) feature can also be provided as a standardized way for specifying an object location identifier for user with mobile entities, including people, websites, and wireless applications.

In accordance with a particular embodiment, a mobile uniform resource locator (MURL) feature can also be provided as a way for sharing and using object location identifier, and particularly for allowing mobile entities to control and share location information using a consumer-friendly URL-like nomenclature. MURL allows for example a user with a cell phone or PDA to share or exchange “who, where, when” location information with another user, or to use their present location information with an application.

Other features and benefits will be evident from the accompanying description.

### BRIEF DESCRIPTION OF THE FIGURES

FIG. 1 is an illustration of a system in accordance with an embodiment that comprises a file of reference and supports assigning geographic markers as object location identifiers (OLI) to objects, information, persons, and applications.

FIG. 2 is a flowchart of a method for assigning object location identifiers to objects, information, persons, and applications in accordance with an embodiment.

FIG. 3 is an illustration of a means of specifying an object location identifier in accordance with an embodiment.

FIG. 4 is an illustration of a means of specifying an object location identifier in accordance with another embodiment.

FIG. 5 is an illustration of a means of specifying an object location identifier, and particularly a moving object location identifier (MOLI), for a moving object in accordance with an embodiment.

FIG. 6 is an illustration of a means of specifying an object with time stamping, in accordance with an embodiment.

FIG. 7 is an illustration of a means of specifying an object location identifier with permissions or granularity, in accordance with an embodiment.

FIG. 8 is an illustration of a system in accordance with an embodiment that supports assigning geographic markers as moving object location identifiers to moving objects.

FIG. 9 is a flowchart of a method for assigning geographic markers as moving object location identifiers to moving objects in accordance with an embodiment.

FIG. 10 is an illustration of a system in accordance with an embodiment that allows ULRO to integrate objects from different third-party files and systems.

FIG. 11 is an illustration of a system in accordance with an embodiment that uses a MURL layer to assign or interpret MURL identifiers with objects, information, persons, and applications.

FIG. 12 is an illustration showing how moving objects, information, persons, and applications can share location information, in accordance with an embodiment.

FIG. 13 is an illustration showing how moving objects, information, persons, and applications can share location information, in accordance with an embodiment.

FIG. 14 is a flowchart showing how moving objects, information, persons, and applications can share location information, in accordance with an embodiment.

FIG. 15 is an illustration of a type of MOLI and/or MURL in accordance with an embodiment.

FIG. 16 is an illustration of a particular example of a MOLI that includes data, in accordance with an embodiment.

FIG. 17 is an illustration of another type of MOLI in accordance with an embodiment.

FIG. 18 is an illustration of another type MOLI in accordance with an embodiment.

FIG. 19 is an illustration of a system in accordance with an embodiment that uses MOLI or MURL with a Web page.

FIG. 20 is an illustration of a system in accordance with an embodiment that uses MOLI or MURL with an electronic document.

### DETAILED DESCRIPTION

Described herein is a system and method for attaching geographical markers to a variety of objects, including real-world objects, electronic documents, people, an individual's software applications, and other items of information. One aspect of this attachment is that the object can be scoped to a particular geographic area, frame of reference, or application, which reduces the need for absolute object coordinates. In accordance with an embodiment, the system can use identifiers such as a latitude/longitude (lat/long) information, or a universal location referencing object (ULRO), to create an object location identifier (OLI). The object location identifier can then be used for mapping real-world objects, electronic documents, people, software applications, inventory and transportable goods, and other items of information.

In accordance with an embodiment, a mobile object location identifier (MOLI) feature can also be provided as a standardized way for specifying an object location identifier for use with mobile entities, including people, websites, and wireless applications.

In accordance with a particular embodiment, a mobile uniform resource locator (MURL) feature can also be provided as a way for sharing and using object location identifier, and particularly for allowing mobile entities to control and share location information using a consumer-friendly URL-like nomenclature, e.g. “MIKE_SMITH.murl”. The MURL then allows for example a user such as Mike Smith with a cell phone or PDA to share or exchange “who, where, when” his location information with another user, or to use their present location information with an application. When a recipient uses the MIKE_SMITH.murl the system automatically retrieves the appropriate name, current location, and other information for that entity.

In accordance with some embodiments, the object location identifier may refer to a moving object (such as a vehicle), rather than a fixed or stationary object (such as a building). In accordance with some embodiments, the MOLI feature can also be provided as a standardized way for people, goods, websites, wireless applications, and other entities to control, share and exchange location information. Both the MOLI feature and the MURL features address a market need to build interoperability between disparate wireless and web based applications that use both that use both digital map data and external location parameters.

In accordance with an embodiment, MURL can be used by an end-user or application in a manner similar to a Uniform Resource Locator (URL) is used in regular Web usage. As described in further detail below, MURLs can be specified using a tag or markup language. Objects can then be placed within MURL lists or nested structures, similar to regular URL. For example, a particular restaurant may be located in a particular city, which in turn is located in a particular state. A MURL can use scoping to control the MOLI's or geographic tags for each of these entities.

In accordance with some embodiments, the system also provides a method and system for creating objection location identifiers, or universal location referencing objects, for use in electronic documents, electronic databases, and electronic maps (which for convenience are collectively termed “electronic files”). In accordance with other embodiments these techniques can be extended to other objects and items of information, including, for example, parcels for delivery (by regular mail or courier), wordprocessed documents, words and paragraphs in electronic documents, email messages, or a person's current location or whereabouts. Since each of these objects or items of information can have an OLI associated therewith, the OLI acts as a location identifier for that object, telling the user “who” and “where” the object is located. In the context of a mobile or moving object the system can associate a MOLI with that object, telling the user “who” and “where” the moving object is located at any particular point in time. In the particular example of a MURL, the system can then take the location identifier and use it similarly to a URL in a Web page, to identify that object or item of information. In either case, the MOLI or MURL can then be searched, communicated and accessed using other applications that require knowledge of the current location of that object or item of information. This allows for example a user with a cell phone or PDA to share or exchange their location information with another user, or to use their present location information with an application.

### Glossary of Terms

The following section defines some of the terms used in the context of this document:

Digital Map Provider—A digital map provider is a commercial, governmental, or other type of entity or company which develops, maintains, and provides a file-of-reference or digital base map, or supplies the data that comprises a file-of-reference or digital base map. Digital map providers can also act as third-party file providers in certain instances. Examples of commercial digital map providers include Tele Atlas, and other mapping companies.

Third-Party—A third-party, third-party data supplied, or third-party data source is a commercial, governmental, or other type of entity, usually separate from the digital map provider, that provides third-party data for use with the file-of-reference or digital base map. If a third-party participates in a joint data-providing operation with the digital map provider, then they may both be considered third-party partners.

File-of-Reference—A file-of-reference is a geospatial database, data structure, document, or digital map used for permanent storage of a document owner's geographic data. A file-of-reference can typically be transformed into other formats that may be more appropriate for certain applications. The term “permanent” as used herein is not intended to imply static, since the data can of course be updated, but instead the term indicates that the data in a file-of-reference is in a more “permanent” storage than the data that is dynamically created in a virtual map in response to a request. In accordance with an embodiment there is only one file-of-reference database. Each other data source or geographic databases are then considered third-party files. However, these are descriptive labels more than anything else, since in other embodiments any of the data files or data sources can act as the file-of-reference, treating the other data files as the third-party files. As used herein, a file-of-reference may sometimes be referred to as a “digital base map”, to illustrate that it is typically provided and marketed by the digital map provider as a digital map.

Third-Party File—A third-party file is also a geospatial database, data structure, document, or digital map used for permanent storage of a document owner's geographic data, the difference being that the data in a third-party file is being supplied by a third-party for use with the file-of-reference. As described above, these titles are intended as descriptive labels more than anything else, since in other embodiments any of the data files or data sources can act as a third-party file, treating the other data file as the file-of-reference.

Virtual Database/Virtual Database System—The virtual database is a means of treating data distributed over multiple databases as if they belonged to a single database. The system that provides a virtual database is then properly referred to as a virtual database system (VDB). The terms “virtual database” and “virtual database system” are somewhat analogous in that they each refer to a system, means, or technique for creating virtual databases or virtual maps, in which objects and features within both a file-of-reference and one or more third-party files, are linked to form a virtual database. In those embodiments that utilize ULROs or similar universal objects, the ULROs may be considered an example of a technology that provides the linkage between a map provider's file-of-reference and the various third-party files. The VDB may then be considered a technology that utilizes such linkage in generating virtual maps.

Virtual Map—A virtual map is an interim database, or in some instances the output of a VDB, and is conceptually the same as the virtual database described above, i.e. it is a means of treating data distributed over multiple map sources as if they belonged to a single map. The term “virtual map” has more real-world connotation that the term “virtual database”, and is essentially a complex digital map. In addition, since the virtual map is created dynamically, at run-time, from a number of otherwise separate sources, it is more flexible, easy-to-update, and thus more useful than a mere compendium of map data.

ULRO—In those embodiments that utilize a universal location record object (ULRO), the ULRO comprises a permanent identification code and sufficient information designed to uniquely identify a particular location within a file-of-reference or third-party file. A location, in turn, can be associated with one or more geographic items. ULROs can be employed to establish traversable links between the file-of-reference and the third-party-files for a broad range of database formats. ULROs can be similarly employed to establish traversable links between two or more third-party files. In some embodiments, the ULRO can refer to the location of either a single map feature, a segment of a map line feature, or a collection of related map features. In some embodiments, the ULRO can encode location information about the object referred to, or it can be simply an assigned number. A map can include a plurality of features which each share the same location, and the same ULRO. Once a ULRO is retired, it cannot be reused. In those embodiments that use ULROs or similar universal objects, the ULROs may be considered an example of a technology that provides the linkage between a map provider's file-of-reference and the various third-party files. The VDB may then be considered a technology that utilizes such linkage in generating virtual maps. Additional information about the use of ULROs is provided in co-pending U.S. patent application “SYSTEM AND METHOD FOR CREATING UNIVERSAL LOCATION REFERENCING OBJECTS”, application Ser. No. 11/271,436, filed Nov. 10, 2005.

Map—As used herein, the term “map” is a generic term that is used to refer to a geospatial database, digital map, or the map data contained therein.

Map Object—A map object is a map item, or more appropriately a data object instantiated within a geospatial database or map.

Feature/Geographic Feature—A geographic feature, also referred to herein simply as a “feature”, is an idealized map representation of an actual object from the real world, which is useful to that map representation. Features can have a dimension, and most often but not always have geometric representations. Features might not be actually visible in the real world: such as borders or intersections, yet notwithstanding this they can still be represented in a map model. Features have a type and a class, which together allow the system to distinguish one feature from another, while also preserving similarities between features that are alike.

Attribute—Features, plurality of features, and sub-sets of features can have attributes. Attributes are provided in large catalogs, and there can be thousands of different attributes applying to features in a commercial computer map model of the real world. The attribute type is what captures the different attributes from the catalogue. Speed limit, length, direction of traffic flow and restaurant opening hours are but a few examples of such attributes.

Relationship—Relationships comprise two or more features “participating” in some meaningful connection to each other. For example, a road element might split into several road elements at some junction, and hence all of those features are in a “fork” relationship to each other (each feature playing a different role). Relationships are also provided in large catalogs, and, as with attributes, hundreds of such relationships are possible in actual commercial digital map models. Not all relationships are geometric, since many are developed by modeling real-world activities. For example, the restaurant that validates parking for a particular parking garage represents one type of business relationship between two features.

Location—The location is defined as where a feature is in the real world, which is a distinct concept from the feature itself. For example, while a feature may be a particular restaurant, its location can be specified as some latitude, longitude (lat/long) coordinate pair, or coordinates from some similar geodetic referencing system, or as a human readable address, (for example “322 Battery Street in San Francisco”). Locations should not be confused with features, or with the other geographic items associated with the locations.

Point of Interest—A point of interest (POI) is a special type of point feature. In particular, the POI is a feature type that can comprise other, more specific types, such as a restaurant, hotel, or museum.

Geographic Marker—A geographic marker, also referred to as a “geotag” is a location identifier. In accordance with an embodiment, the geographic marker includes lat/long, ULRO or other location information. The geographic marker can be considered a succinct, standardized universal location coding for everywhere on earth, and can be attached to an object. Examples of database-specific navigation features include an objects latitude and longitude (lat/long) information, and advanced featured such as ULRO, an example of which is described in further detail in co-pending U.S. patent application “SYSTEM AND METHOD FOR CREATING UNIVERSAL LOCATION REFERENCING OBJECTS”, application Ser. No. 11/271,436, filed Nov. 10, 2005.

Object Location Identifier—The Object Location Identifier (OLI) provides information about the identity of an object, and the location of that object. In accordance with an embodiment, the OLI includes an object identifier and a geographic marker or geotag.

Mobile Object Location Identifier—The Mobile Object Location Identifier (MOLI) is similar to the standard OLI described above, but is identified a mobile OLI to indicate that it provides information about the identity of a moving object, and the location of that moving object. In accordance with an embodiment, the MOLI includes an object identifier and a geographic marker or geotag.

MURL—In accordance with a particular embodiment, the MURL is a particular form of addressing a MOLI to provide or extract who/where identification for a mobile or moving object, using a consumer-friendly URL-like nomenclature, e.g. “MIKE_SMITH.murl”. The MURL then allows for example Mike Smith to provide his MURL to another user. When a recipient uses the MIKE_SMITH.murl the system automatically retrieves the appropriate name, current location, and other information for that entity.

In accordance with some embodiments the system can also be used to track documents, such as word processing documents, portions of documents, and email messages. Currently available computer and email systems utilize hard-coded computer features such as the sender's Internet protocol (IP) address to track documents and messages such as email. However, it is not easy to convert an IP address into geographic locations. In some instances lookup tables can be used, but there is no guarantee that they are accurate, or publicly available. There may also be problems due to mistakes in the computer's IP address. Worse yet, a common problem nowadays is the concern for IP masking, which can be used to infiltrate a system's security and hide the original location of a file or message. Additionally, many portable or intermittently connected computers such as laptops have dynamic IP's that are assigned when talking to another computer, but otherwise can change regularly.

In accordance with embodiments of the present invention, a geographic marker or geotag is created. The geographic marker can be considered a succinct, standardized universal location coding for everywhere on earth. The geographic marker can then be attached to one of an electronic object or in some embodiments to a non-electronic object. In according with embodiments that use electronic objects, the electronic object can be located in one of a computer file, a database, an email, a web page, or another type of electronic or computerized document, or portions of that document. The creation of the geographic marker and its subsequent attachment to the electronic object enables spatial connectivity between that object and other objects. The creation of the geographic marker and its subsequent attachment to the electronic object also enables spatial connectivity between the object and one or more maps. In the context of an electronic document or web page, such as a wordprocessed document, or an email, the creation of the geographic marker and its subsequent attachment to the electronic document also enables spatial connectivity between the document and one or more maps.

With the ability to add geographic markers to electronic documents and messages, an element of dynamicity is introduced, together with the capability to quickly respond to changes. The geographic marker can tell the object one or more of its current location and its desired location. According to one set of embodiments, a desired location is derived from the projected or known destination of a vehicle that is carrying the object. Embodiments of the invention thus allow an operator to make an automated query and to obtain a succinct geographic marker for the object, without having to enter commands in English or another language. As the object moves, the underlying lat/long or ULRC information changes, which means the geographic marker or tag also changes. In accordance with an embodiment a MOLI or MURL later can be used to access the geographic marker, and determine the objects current location.

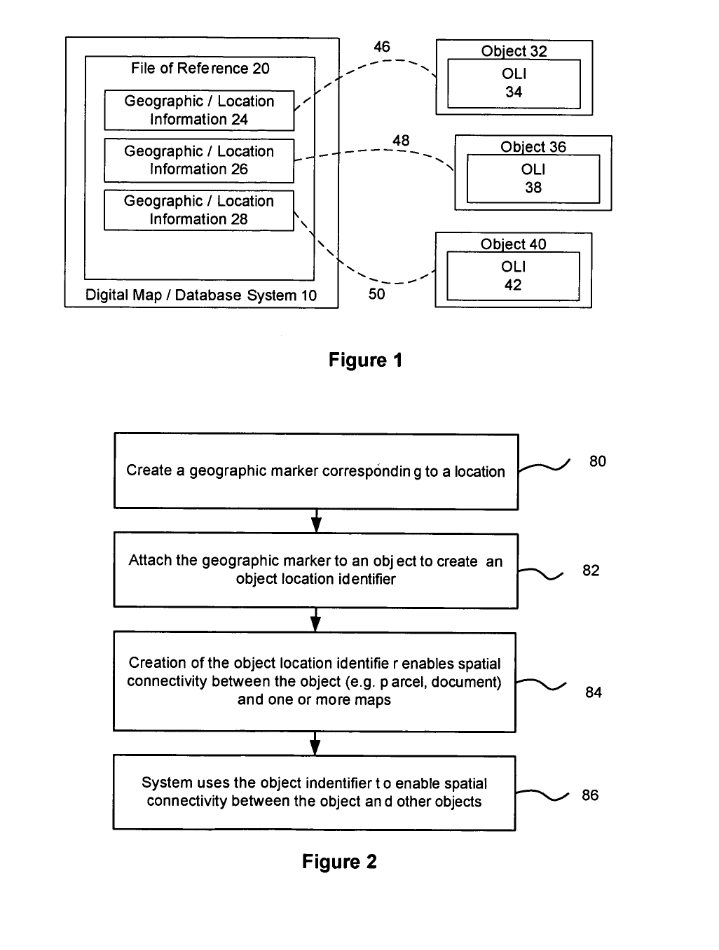

FIG. 1 is an illustration of a system in accordance with an embodiment that comprises a file of reference and supports assigning geographic markers to objects, information, persons, and applications. As shown in FIG. 1, the system 10 can include a file of reference or other map database 20, which includes location information 24, 26, 28 for a plurality of objects 32, 36, 40. Each object can include an object location identifier (OLI) 34, 38, 42 that can include a geographic marker for the object.

FIG. 2 is a flowchart of a method for assigning referencing objects geographic markers to objects, information, persons, and applications in accordance with an embodiment. As shown in FIG. 2, in step 80 the system creates a geographic marker corresponding to a location. In accordance with various embodiments the geographic marker can include lat/long or other location information, including in some embodiments height, altitude or similar information. In a particular embodiment the geographic marker comprises a standardized universal code encoding a particular location. In step 82, a geographic marker is attached to an object. In step 84, the attachment of the geographic marker to the object creates an object location identifier (OLI) and enables spatial connectivity between the document and one or more maps. In step 86, the geographic marker enables spatial connectivity between the object and other objects.

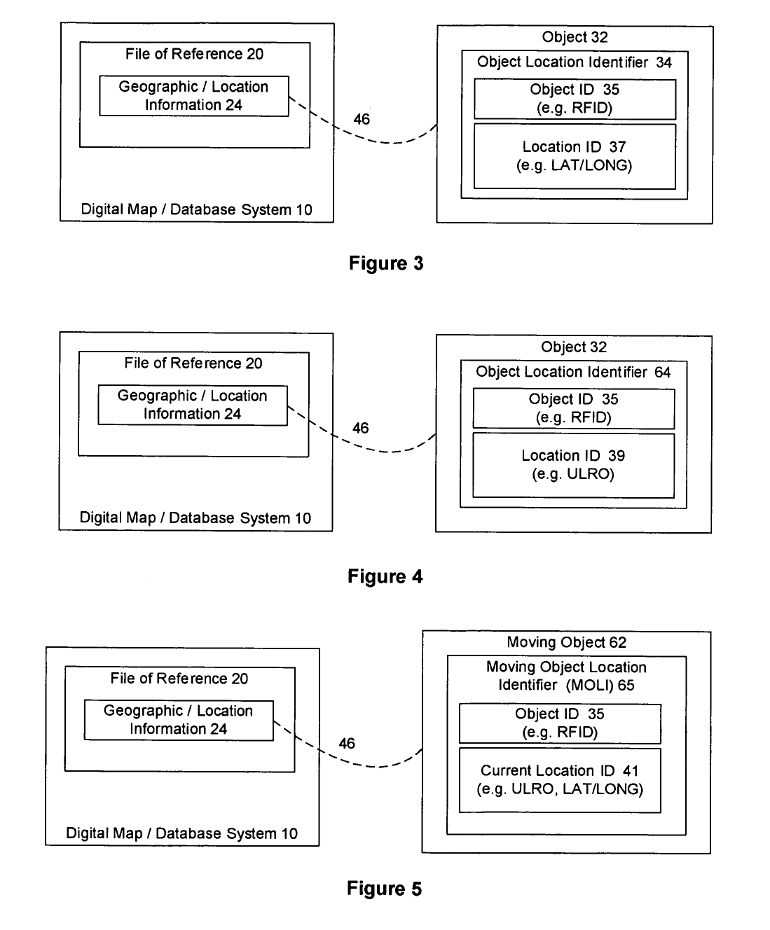

FIG. 3 is an illustration of a means of specifying an object location identifier (OLI) in accordance with an embodiment. As shown in FIG. 3, an object has an object location identifier 34 associated therewith. Each object location identifier includes object identification information 35 (for example, an RFID tag) that provides “who?” information about the object, and object location information 37 (for example, a lat/long) that provides “where?” information about the object.

FIG. 4 is an illustration of a means of specifying an object location identifier in accordance with another embodiment. As shown in FIG. 4, the object location identifier 64 can use different combinations of who and where information. In the example shown in FIG. 4, each object location identifier includes object identification information 35 (again, an RFID tag) that provides “who?” information about the object, and a universal object location information ULRO that provides “where?” information about the object.

In accordance with an embodiment, markers can be dynamically assigned to both static objects and to moving objects. In this context a static object may, for example, be a company or business location, or a roadway.

FIG. 5 is an illustration of a means of specifying an object location identifier, and particularly a moving object location identifier (MOLI), for a moving object in accordance with an embodiment. A moving object may, for example, be a delivery truck, or a parcel on the truck bound for delivery, or an email message in communication from one computer system to another computer system, or a person walking with a PDA device. Using the above technique, the moving object can have a lat/long, ULRO, or another form of geographic marker or identification associated therewith. As shown in FIG. 5, a moving object has a moving object location identifier 65 associated therewith, which is essentially an OLI used for the purpose of a moving object. Each object location identifier again includes object identification information 35 (for example, an RFID tag) that provides “who?” information about the object, and object location information 37 (for example, a lat/long or a ULRO) that provides “where?” information about the object.

By way of example, if the system is used to track (or “ping”) a delivery truck, then two geographic markers are received: the first marker can be the current location, and the second marker can be the ultimate destination. As the location of the delivery truck changes, so does its geographic marker. This allows the pinging of the geographic marker to be used to determine the location of a moving (or indeed stationary) object, at a particular point in time.

In accordance with an embodiment, the system facilitates the association of a location with a geographic marker and an object, be it a computer object, electronic object, cyber object, or a physical object in the real world. This association enables the querying of any object with a geographic marker as to where that object is. It is also possible to query the location of certain services or products under a wide range of user-selected constraints. For example, a user can state on a Web-based search page or application that he/she is interested in getting a haircut in San Francisco, Calif., after delivering a parcel to that town, and can query the location of San Francisco hairdressers. If all local hairdresser web pages are published using a geographic marker, then the most pertinent pages can be quickly and easily located. In accordance with an embodiment the system can automatically exclude geographically irrelevant results, so in this instance the location of the web server itself would be irrelevant.

In accordance with an embodiment, electronic-object and document-based markers can be implemented using latitude and longitude (lat/long, and, where available, azimuth) as the geographic marker. In an alternative embodiment the system uses universal location referencing objects (ULRO). Alternative embodiments can use any other organized mapping between locations and indices or numbers such as zip codes. Techniques such as GPS can be included to better get a “fix” on an item and augment the items geographic location information; while techniques such as radio frequency identification (RFID) tags can also be included to better identify an item. Particularly, since RFID tags are nowadays relatively inexpensive, they can be added to almost any item, large or small, that warrants tracking. As described below, another alternative set of embodiments uses unique mobile identifiers (MOLI's and MURLs) that are particularly suited for mobile applications and/or for consumer-friendly applications.

In accordance with an embodiment, when the system associates a geographical marker with a physical object, it can be visualized as a geographic beacon on that object. In the above example of the parcel traveling to San Francisco, Calif. on a delivery truck, this can be visualized as a geographic beacon placed on the truck. As the truck moves, the beacon reads the parcel's current location, and gives the updated answer when queried. In one set of embodiments, the beacon is capable of translating between different formats, for example, from ULRO's to lat/long, or between other formats.

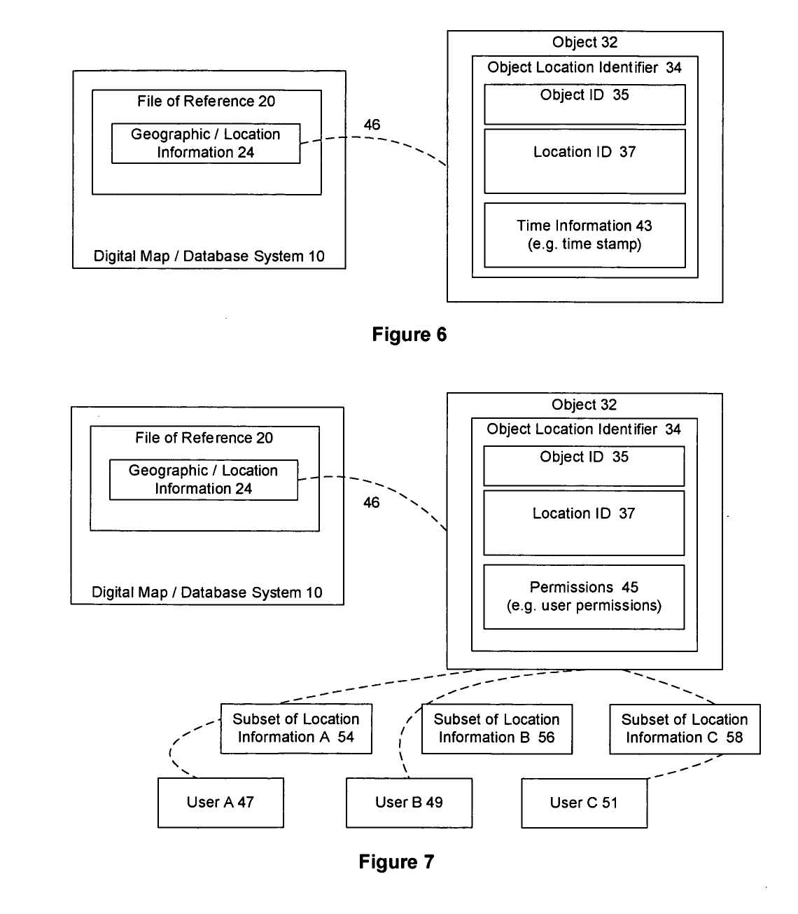

FIG. 6 is an illustration of a means of specifying an object location identifier with time stamping, in accordance with an embodiment. As shown in FIG. 6, an object has an object location identifier or OLI 34 (or in the case of a moving object a MOLI) associated therewith. In accordance with an embodiment, each OLI or MOLI can also include a time information 43, that adds a further dimension to the who/where information stored therein, namely when? An example of the time information that can be used are absolute time stamps, or periodic time counts. This information can then be used to track or provide “breadcrumbs” for the objects as its location changes over time, and is particularly useful for those objects whose position is rapidly changing.

FIG. 7 is an illustration of a means of specifying an object location identifier with granularity, in accordance with an embodiment. As shown in FIG. 6, an object has an object location identifier or OLI 34 (or in the case of a moving object a MOLI) associated therewith. In accordance with an embodiment, each object location identifier can also include permission information 45 that determines under what conditions the OLI or MOLI will be provided to a requestor or recipient. An example of permissions information that can be used is user permission, i.e. which users or set of users are allowed to access the location identifier and the information therein. Other examples of permissions that can be used are the type of application the location identifier is being used for, or time permissions. As further shown in FIG. 7, permissions can be used, for example, to allow certain users to access some or all of the location information for a particular object's OLI or MOLI. In accordance with an embodiment, a plurality of users 47, 49, 51 can have different access rights or granularity to access the OLI information. The system applies the user permissions to provide different (partial or complete) OLI or MOLI information 54, 56, 58 to each user respectively.

In accordance with a particular embodiment, the system can comprise a MOLI or MURL layer that allows for identification, location determination, and tracking of mobile or moving objects.

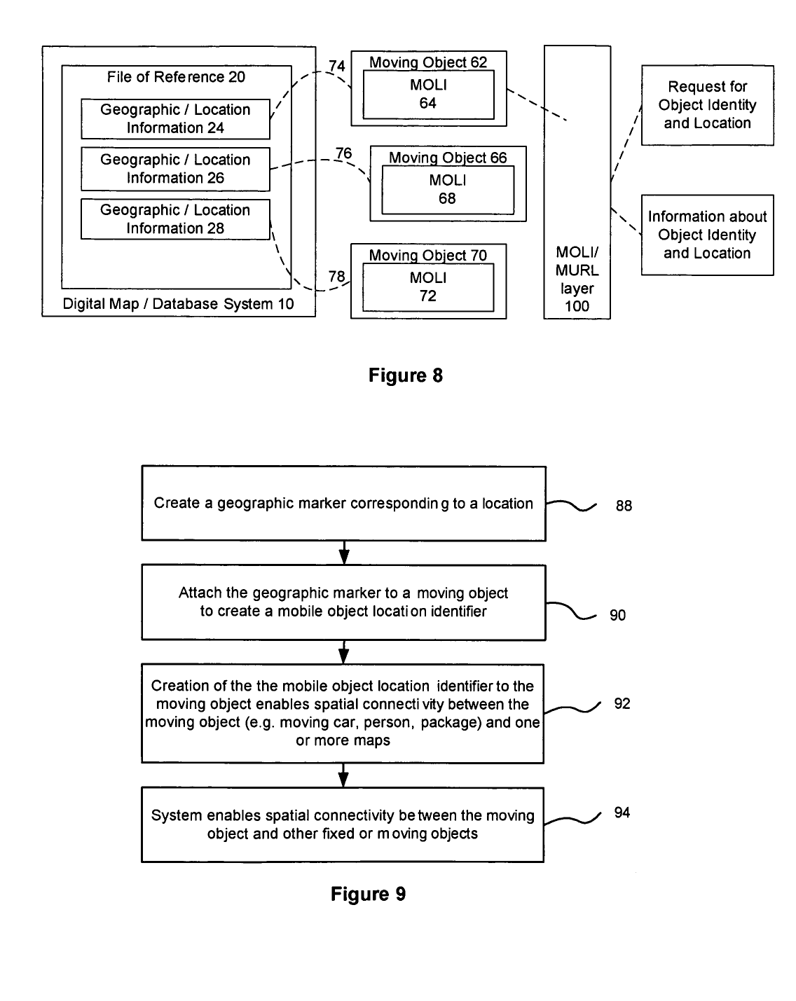

FIG. 8 is an illustration of a system in accordance with an embodiment that supports assigning geographic markers as MOLI and/or MURL to moving objects. As described above, the Mobile Object Location Identifier (MOLI) provides information about the identity of a moving object, and the location of that moving object. The MURL is a particular form of addressing a MOLI to provide or extract who/where identification for a mobile or moving object, and provides a standardized way for specifying an object location identifier for user with mobile entities, including people, websites, and wireless applications. As shown in FIG. 6, a MOLI/MURL layer 100 can be provided, that allows a request to be made for an objects location, specifying a particular MOLI or MURL. In return the system can identify the object, and can determine the current location for that object. Similarly, objects can provide MOLI's or MURLs to indicate their identity and their current location.

FIG. 9 is a flowchart of a method for assigning geographic markers as moving object location identifiers to moving objects in accordance with an embodiment. As shown in FIG. 9, in step 88 the system creates a geographic marker corresponding to a location. In accordance with various embodiments the geographic marker can include lat/long or other location information. In a particular embodiment the geographic marker comprises a standardized universal code encoding a particular location. In step 90, a geographic marker is attached to a moving object. In step 92, the attachment of the geographic marker to the moving object creates a moving object location identifier (MOLI, or in some embodiments a MURL) and enables spatial connectivity between the document and one or more maps. In step 94, the geographic marker enables spatial connectivity between the object and other objects.

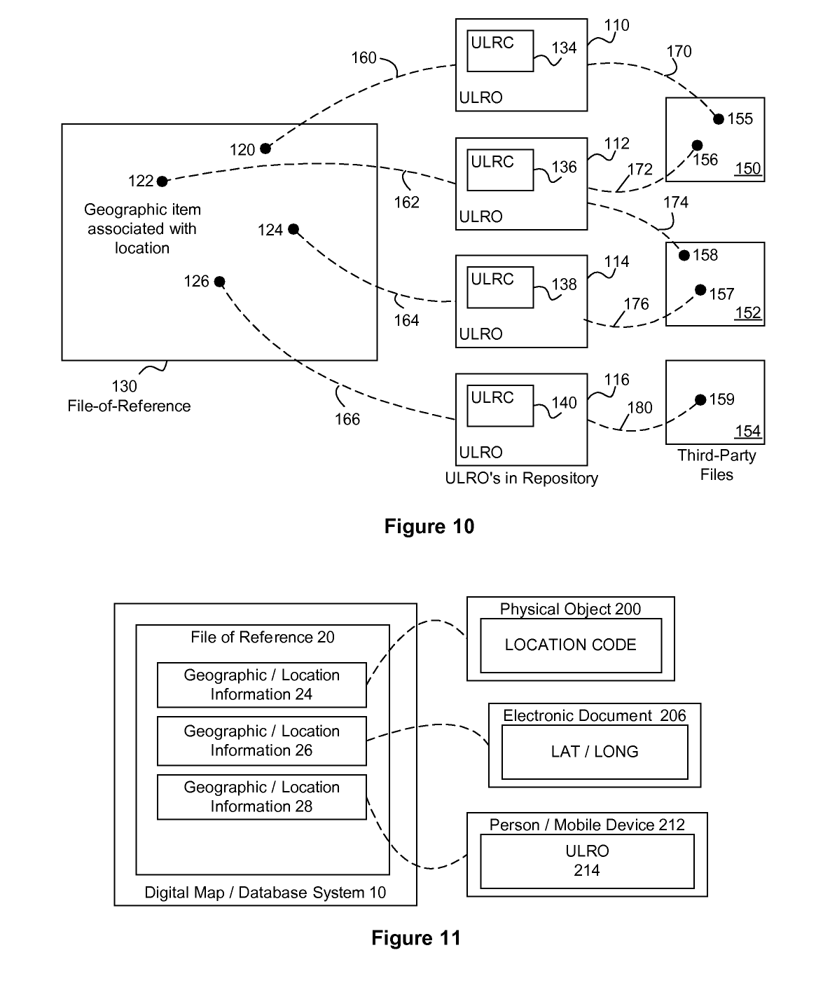

FIG. 10 is an illustration of a system in accordance with an embodiment that allows ULRO to integrate objects from different third-party files and systems. The ULRO technique is described in further detail in co-pending U.S. patent application “SYSTEM AND METHOD FOR CREATING UNIVERSAL LOCATION REFERENCING OBJECTS”, application Ser. No. 11/271,436, filed Nov. 10, 2005. As described above, in accordance with one embodiment, ULRO's can be used to provide the location information for an object, which in turn will be used as part of the OLI. As shown in FIG. 10, ULROs can be assigned to geographic items associated with a location 120, 122, 124, 126 in an electronic file-of-reference 130. The geographic items can be any of a feature, a plurality of features, a sub-set of features, or an attribute associated with a physical location, so that in FIG. 10 the geographic items 120, 122, 124, 126 may in actuality be associated with a single physical location. In accordance with an embodiment ULROs 110, 112, 114, 116 comprise respectively ULRC's 134, 136, 138, 140. Each ULRC may in turn comprise a permanent identifier or permanent ID. The ULRO can be easily and accurately maintained and updated, and can be used to link the geographic items associated with locations in the file-of-reference with corresponding location information 155, 156, 157, 158, 159 in one or more third-party files 150, 152, 154. As shown in FIG. 10, a single geographic item associated with a location, for example location 120, may be linked to a single ULRO 110 that links to a single third-party file 150. Alternatively, a single geographic item associated with a location, for example location 122 may be linked to a single ULRO 112 that links to a plurality of third-party files 150, 152. Furthermore, links 160, 162, 164, 166, 170, 172, 174, 176, 180 can be either unidirectional pointers, bi-directional pointers, or a mix of both unidirectional and bi-directional pointers. While in FIG. 10, the file-of-reference 130 appears as a base map, it is also possible to treat any of the third-party files equally as the file-of-reference, and for the locations therein to be similarly linked to information in the other files. In accordance with an embodiment, the ULRO technique can be used for other objects, including electronic objects, people, mobile devices, and software applications.

FIG. 11 is an illustration of a system in accordance with an embodiment that uses ULRO to assign geographic markers to objects, including information, persons, mobile devices, and applications. As shown in FIG. 11, the system 10 can include a file of reference or other map database 20, which includes location information 24, 26, 28 for a plurality of objects, including physical objects 200, electronic documents 206, and persons or mobile devices 212. Each object can include a lat/long, ULRO, or other object location identifier 202, 208, 214 that can be used as a geographic marker for the object. In accordance with some embodiments, the system comprises a MOLI or MURL layer 100 that allows for identification, location determination, and tracking of mobile or moving objects.

In accordance with some embodiments, the dynamic information for a particular object may not be immediately available. For example, in the instance described above of a delivery truck, the parcel's current location may not be available. In this case, to know the parcel's destination, the driver of the truck can program the truck's destination into the system. Translation software contained within the beacon can transmit the association of the parcel with the geographic marker for San Francisco, Calif. In accordance with some embodiments, a geographic marker can also be defined for the origin of the truck carrying the parcel. A bracketing technique can then be used to predict where the truck or parcel is at any particular point in time, based on its last known location and time stamps. The system can then estimate the approximate location between the start and end points. This is potentially useful if the one or more of the object and the vehicle are, for example, potentially related to a crime, or used in a lost-and-found application, or if it is desired to track the demographics of vehicles leaving a certain location. In accordance with some embodiments, a tiny marker device may be imbedded in an object of interest, wherein the device comprises a standardized geographic marker for the address of ownership. This facilitates the regaining of lost objects, even if the object is found in a location where a different language is spoken from that spoken in the location where the object was lost.

In accordance with some embodiments, geographic markers can be used to restrict searches for objects that are related to certain locations. Using the geographic markers, a search is limited by the corresponding, geographically relevant restrictions. For example, a web site that describes the state of California for a tourism association can be associated with the ULRO for the state of California. The pages that address Los Angeles will be associated with the ULRO for the city of Los Angeles. Restaurants and hotels will each be associated with a ULRO through their addresses. When a web search is subsequently performed that receives this site or some pages from it as one result, the search focuses on results including an HTML tag storing the appropriate geographic marker or markers. Depending on the specific query and the user's specific needs, the geographic markers of interest may correspond one or more of California, Los Angeles, and a particular restaurant address. In this instance, geographic markers behave like geographic keywords, greatly facilitating searches in which geographic location is a criterion. Typically, geographic markers can help eliminate a high proportion of all candidate search results, allowing a user to focus on truly useful and relevant results. In accordance with an embodiment, a bracketing technique can be used as described above, in which a start point and an end point is determined, together with appropriate time stamps, and geographic markers for each point. The system can then estimate the approximate location between the two points. In accordance with an embodiment, the system uses the who and where information provided by the geographic marker, together with the times stamp information to collect triple data points.

In accordance with some embodiments, markers can be used with electronic mail messages (“email”). According to these embodiments, geographic markers are appended to an email message to represent one or more of the origin of the message, the destination of the message, and intermediate points traversed by the message during its path from origin to destination. According to one set of embodiments, geographic markers are appended to an email message to represent its origin. According to one set of embodiments, geographic markers are appended to an email message to represent its destination. The content of an email message can also be “geotagged” or have geographic markers associated therewith.

In accordance with some embodiments, geographic markers allow widely varying applications to unify object location information based on the fact that everything (and perhaps every person) has a geographic marker. Here, one application is to make all knowledge linkable to geographic searches that don't require heavy automated searching. For example, everybody that publishes a web page wouldn't have to know how to write those markers; they could instead use a software service on the web that would generate markers if they input their address, etc. Programs can translate from systems which humans know, into coordinates to universal system of geographic markers.

In accordance with some embodiments, geographic markers are added to fields pertaining to items in a database. Any field of interest in a database can be associated with a geographic marker. Lookup tables for conversion from one format to another can be implemented rapidly and efficiently. As examples only, possible applications include asset tracking, insurance coverage databases, and inventory. The need for inputting addresses is thereby avoided, potentially saving money and storage space. The data thereby becomes more robust, and easier to correlate.

With geographic markers, searches that will enable disparate knowledge to come together, linked on location, are made possible or are made much more efficient. Palmtop computers, cellular telephones, and personal digital assistants (PDA's), which do not have a lot of power or memory, will benefit from use of geographic markers. Geographic markers facilitate location-based services, according to which a user's location affects results. As one example, when a user enters San Francisco, based on his standard declared interests and also based on the PDA's location, his/her PDA interfaces to advertisements relevant to his location and notifies him/her accordingly.

### Mobile Uniform Resource Locator (MURL)

In accordance with a particular embodiment, a mobile uniform resource locator (MURL) feature can also be provided as a standardized way for people, websites, and wireless applications to control, share and exchange location information. As described above, the MURL is a particular form of addressing a MOLI to provide or extract who/where identification for a mobile or moving object using a consumer-friendly URL-like nomenclature, e.g. “MIKE_SMITH.murl”. The MURL then allows for example Mike Smith to provide his MURL to another user. When a recipient uses the MIKE_SMITH.murl the system automatically retrieves the appropriate name, current location, and other information for that entity. The MURL addresses the market need to build interoperability between disparate wireless and web based applications that use both digital map data and external location parameters.

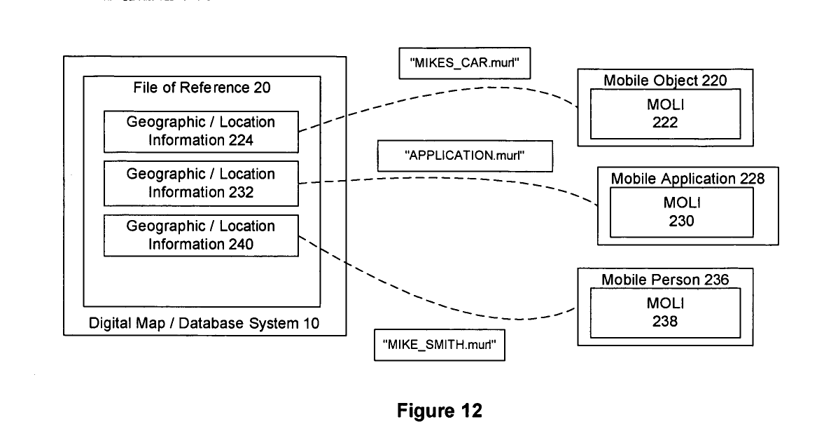

FIG. 12 is an illustration of a system in accordance with an embodiment that assigns MOLI or MURL to objects, information, persons, and applications. As shown in FIG. 12, the system 10 can include a file of reference or other map database 20, which includes location and/or MOLI or MURL information 224, 232, 240 for a plurality of objects, including mobile objects 220, mobile applications 228, and mobile persons or mobile devices 236. Each object can include a MOLI 222, 230, 238 that can be used as a geographic marker for the object. Depending on the particular embodiment a user friendly MURL can also be assigned to the object, such “MIKE_SMITH.murl”. Either the MOLI or the MURL can be used to identify the object.

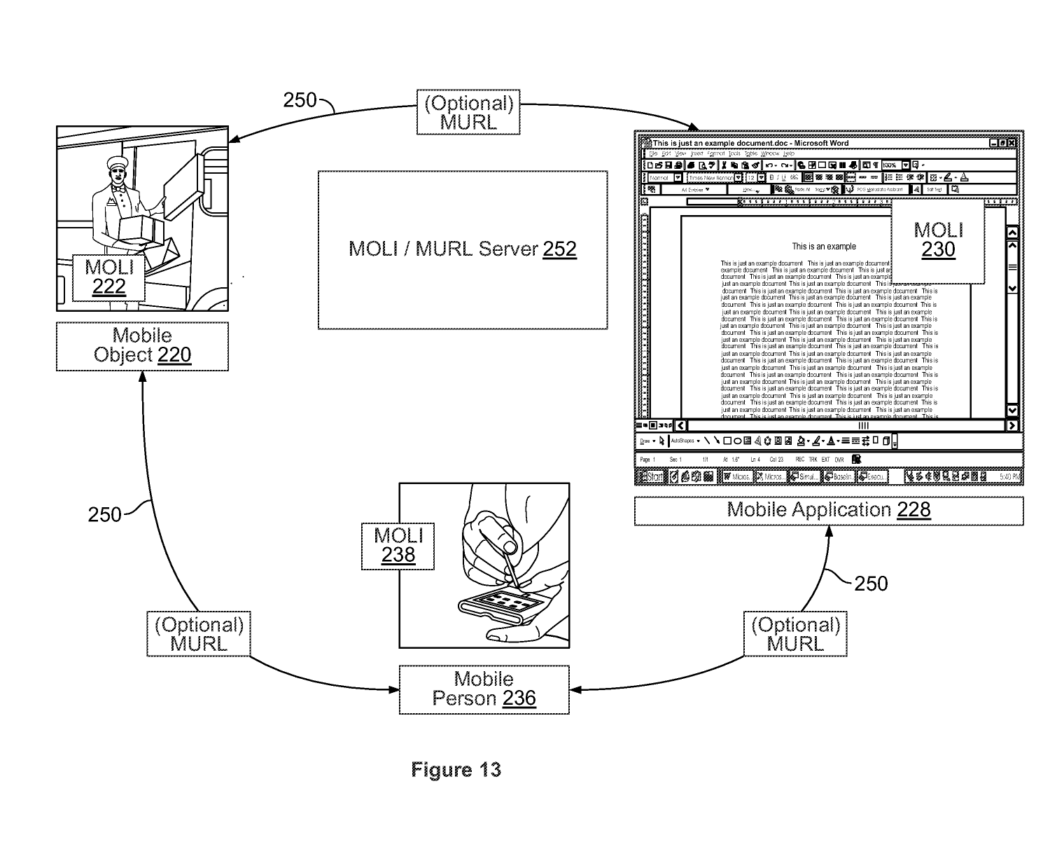

FIG. 13 is an illustration showing how multiple objects, information, persons, and applications can share location information using MOLI or MURL in accordance with an embodiment. As shown in FIG. 13, by way of example, each of the mobile objects, mobile applications, or mobile persons can communicate MOLI information 222, 230, 238 between one another 50, for use in determining a geographic marker for the object and/or the current geographic location. This geographic location information can then be used by the objects or by other systems, for tracking, navigation, route-finding, and other applications. In accordance with an embodiment a MOLI/MURL server 252 controls the sharing of information between users and applications, including where necessary performing the tasks of the MOLI/MURL layer in translating between MURL and the underlying MOLI.

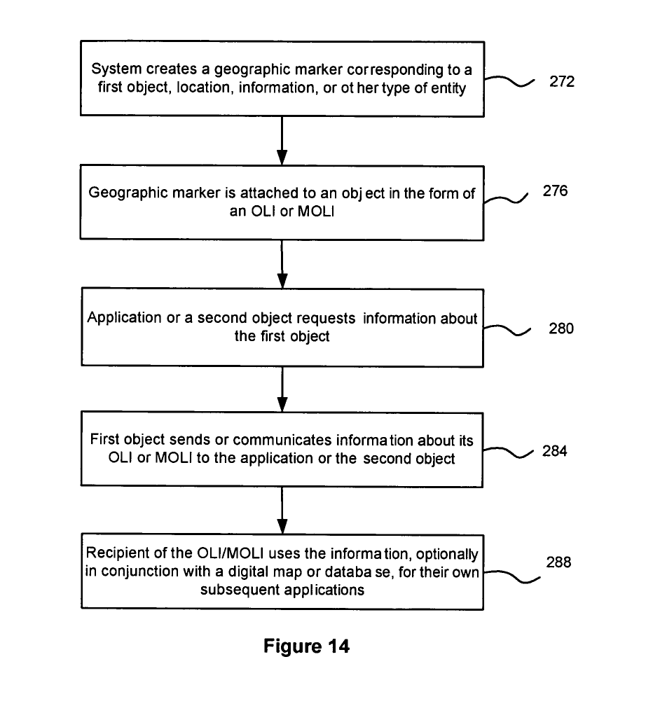

FIG. 14 is a flowchart of a method in accordance with an embodiment, for using geographic markers with objects, information, persons, and applications. As shown in FIG. 14, in step 272 the system creates a geographic marker corresponding to a first object, location, information, or other type of entity, wherein the geographic marker comprises a standardized universal code encoding a particular location. In step 276, a geographic marker is attached to an object in the form of an OLI or MOLI. In step 280, an application or a second object requests information about the first object. In step 284, the first object sends or communicates information about its OLI/MOLI to the application or the second object. In step 288, the recipient of the OLI/MOLI uses the information, optionally in conjunction with a digital map or database, for their own subsequent applications, including for example tracking, route-finding, or in the case of a MURL using the geographic marker information in the MURL to retrieve additional geographic-related and other information.

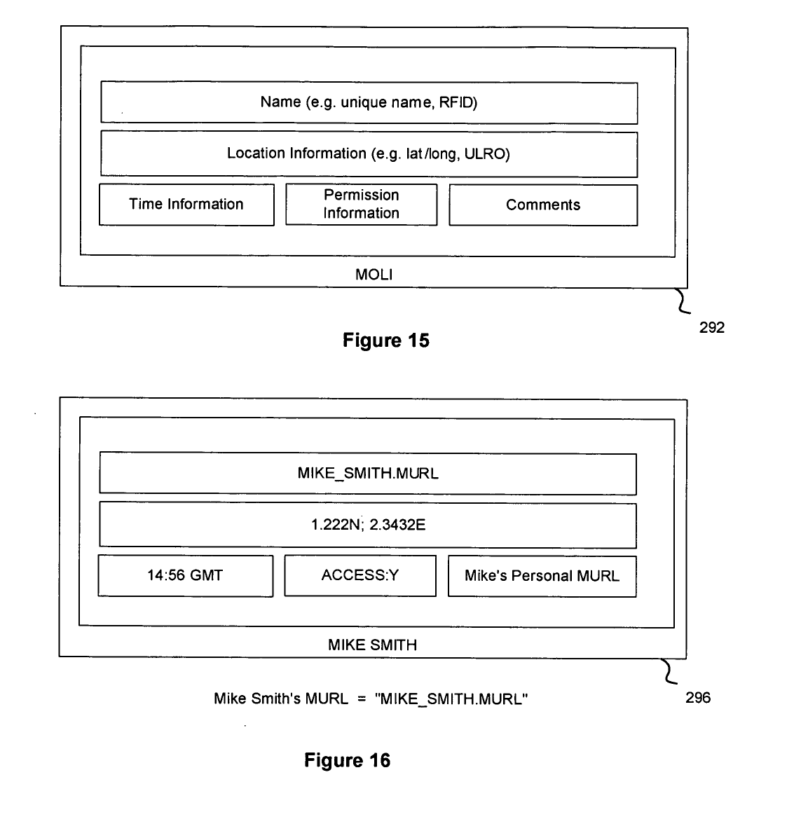

FIG. 15 is an illustration of a type of MOLI and/or MURL in accordance with an embodiment. As shown in FIG. 15, in accordance with an embodiment, an OLI or MOLI 292 can have a data format such as:

{M}OLI = <Latitude> <Longitude> <TimeStamp>
<ExpirationDateTime>
<Comment> <Privacy:Total/Partial/None>

wherein the field definition can be:

<Latitude> - Entity's latitude;
<Longitude> - Entity's longitude;
<TimeStamp> - A time entry, such as ZULU time;
<ExpirationDateTime> - An expiration time entry (in ZULU time);
<Comment> - Optional Comment, e.g. “Amazing view right here”;
<Privacy:Total/Partial/None> - Permission to access or forward info.

FIG. 16 is an illustration of a particular example of a MOLI that includes data, in accordance with an embodiment. As shown in FIG. 16, the example 296 therein is for Mike Smith's MOLI, and comprises a name identifier (in this instance “MIKE_SMITH.murl”), coordinates in lat/long format, a GMT time identifier, access permissions, and comments. In those embodiments that use MURL, Mike Smith's MOLI can be referred to or accessed using the identifier “MIKE_SMITH.murl”.

In accordance with other embodiments other data formats can be used for the MOLI that comprise different fields. For example, in some embodiments, the MOLI can include a destination field. In accordance with other embodiments, the use of lat/long can be replaced with a ULRC or other location identifier. In accordance with other embodiments, the lat/long information can be supplemented with a height or altitude information.

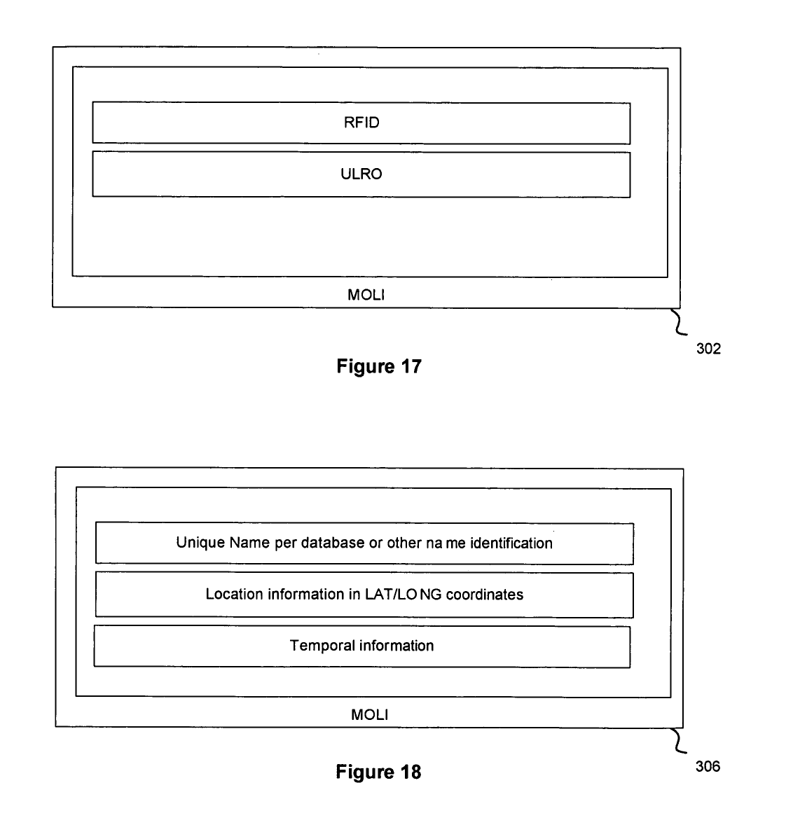

FIG. 17 is an illustration of another type of MOLI 302 in accordance with an embodiment. As shown in FIG. 17, an embodiment of an OLI or MOLI can simply include an RFID (providing “who” information), and a ULRO (providing “where” information). in accordance with an embodiment, an OLI or MOLI 302 can have a data format such as:

{M}OLI = <RFID> <ULRO>

wherein the field definition can be:

<RFID> - Entity's RFID identification;
<ULRO> - Entity's ULRO.

FIG. 18 is an illustration of another type MOLI 306 in accordance with an embodiment. As shown in FIG. 18, an alternative embodiment of an OLI or MOLI can simply include a unique name information (as stored in a database or other name repository), location information in lat/long coordinates, and temporal information. It will be evident other data arrangements and data formats can be used within the spirit and scope of the invention, including any combination of information that can be used to provide “who” and “where” information for the OLI or MOLI. In accordance with an embodiment, an OLI or MOLI 306 can have a data format such as:

{M}OLI = <Name> <Latitude> <Longitude> <TimeStamp>

wherein the field definition can be:

<Name> - Entity's Name;
<Latitude> - Entity's latitude;
<Longitude> - Entity's longitude;
<TimeStamp> - A time entry, such as ZULU time.

In accordance with other embodiment, an OLI or MOLI can have any of a variety of other data formats such as, by way of example:

{M}OLI = <Latitude> <Longitude> <Comment>
{M}OLI = <Latitude> <Longitude> <TimeStamp> <Privacy>
{M}OLI = <ULRO> <TimeStamp> <Comment>
{M}OLI = <ULRO> <Comment> <Privacy:Total/Partial/None>

Other arrangements of fields, or combinations thereof, data arrangements and data formats can be used within the spirit and scope of the invention to best suit the needs of a particular implementation, including any combination of information that can be used to provide “who” and “where” information for the OLI or MOLI.

### OLI/MOLI/MURL Applications

As described both MOLI and MURL provide a way standardized way for people, websites, and wireless applications to control/share location information. MOLI and MURL address the market need to build interoperability between disparate wireless and web based applications that use both location functionality, and data from a map database, digital map, or file of reference. To date there has been no simple or consistent way for users of mobile and web based applications that use location as a key application feature, to control and exchange information about their location. MOLI is intended to address this in order to give users control over if, how and when their location information is delivered between applications. In addition, MURL provides individual users with an easy-to-use mechanism to manage their personal profile, which is stored on a remote server, thereby enabling the individual user to determine the criteria and conditions under which their location information is sent. MURL also enables the creation and growth of social networking communities, by encouraging users of applications to communicate using location and digital maps as a means to interact between family and friends, and between individuals with similar stored profiles. The MURL protocol and format also enable businesses to make their location readily available to distinct groups of end-users, and to other businesses, opening up opportunities for location based advertising and other new services, with the advantage that the businesses have control over the access rights to their location information, and who can receive it.

Similarly with the geographic tag feature and ULRO described above, OLI, MOLI and MURL can be used in a variety of different implementations, including for example:
Program to user
User to program
Program to program
User to user

Users can be individuals or corporations. Programs can be mobile applications, web sites, Enterprise Resource Planning implementations, or any other digital application or electronic document or information which might include address or location data.

### 1. Program to User—Consumer User Examples

The following dialogs illustrate the use of object location identifiers in a program to user—consumer user example:
A. “Jill has requested your MURL. Since she is on the approved list to access your location, I'm displaying your location on a map and sending directions to her.” In this example, Jill has actually requested a geographic marker or geotag for an entity, and has specified the entity's name using the user-friendly MURL style of request (i.e. by asking for Mike Smith's MURL). Since the system knows which OLI/MOLI includes which geographic marker, it can retrieve the relevant location information associated with that MURL and provide that to Jill. Although Jill does not need to know the “when?” component, this particular implementation provide to Jill only the information she needs, and simply disregards any other information that may be associated with the MOLI.
B. “Here is the location of the Shell station you are looking for.” This example is similar to the previous one, in that it is a request for a geographic marker or geotag. Again, since the system knows which OLI includes which geographic marker, it can retrieve the relevant location information and provide that to the requesting user.
C. “The friend you're looking for is 200 feet up the hill on your left.” This example is similar to A above, in that it is a request for a geographic marker or geotag.

### 2. Program to User—Business User Examples

The following dialogs illustrate the use of object location identifiers in a program to user—business user example:
A. “The two large pepperoni pizzas go to this address.” In this example, the user is directing a delivery to a geographic marker, in this instance specified by a particular address. An alternative means of specifying delivery might be to send the pizzas to e.g. Mike Smith's MURL. In that instance since the system can determine Mike Smith's MOLI, it can provide an updated location information to the pizza delivery person, even if Mike Smith changes his current location.
B. “We have had three reports of dangerous potholes on this street.” This example is again a status information about a geographic marker or geotag. However, if the potholes are given some form of identification number, such as an RFID tag, then they can be tracked using the MOLI and MURL approach.

### 3. User to Program

The following dialogs illustrate the use of object location identifiers in a user to program—consumer user example:
A. “Here's who I am and where I am; allow my list of people access to my location information.” In itself, this is merely a request to set permission on a geographic marker. However, the permission information can also be incorporated into a OLI/MOLI in the same fashion.
B. “I've just landed safely; alert my wife and my mother that everything is fine.” In this example, the geographic marker is published in response to a specific event happening, in this instance the person's plane landing. If the person's wife and mother are specified in the system as MURL's then the system can use the location information and rules associated with those MURL's to deliver the published information (perhaps by sending the information using different methods at different specified times).

The following dialogs illustrate the use of object location identifiers in a user to program to user—business user example:
A. “Starbucks opened the following twelve stores this week. Insert these locations on Mapquest.” This example illustrates the use of an OLI or MOLI's “Who/Where” feature to quickly provide geographic information to a repository, in this instance a directory of coffee shop information. Each of the stores can also be associated with a MURL for ease of identification.
B. “I have delivered parcel #1234567 to this address.” This is a request for update to a geographic marker or geotag. As with the earlier examples, since the system knows which MOLI includes which geographic marker, it can update the relevant location information for that MOLI.

### 4. Program to Program

The following scenarios illustrate the use of object location identifiers in a program to program—consumer user example:
A. Phone-resident application sends “breadcrumb” trail to application so that parent can track teenage driver. In this example, the system can make used of the optional “When?” feature of the OLI/MOLI to provide additional information about an object over time, or determine particular events, such as calculating an average speed of a moving object, or determine if a predefined speed limit has been breached.
B. User sets permissions so that his boss can query his location 9-5, and his spouse can find him 24×7 (or vice versa). In this example, the system can make use of the optional permissions feature of the OLI/MOLI to allow access to/from certain users, at certain times. This can provide a measure of granularity or filtering capability to the provision of object location information.

The following scenarios illustrate the use of object location identifiers in a program to program—business user example:
A. Local “find” application harvests all of new Starbucks, McDonalds, etc nightly to ensure currency. This is again a request for update to a geographic marker or geotag. As with the earlier examples, since the system knows which OLI includes which geographic marker, it can update the relevant location information for that object. This example also illustrates the use of an OLI's “Who/Where” feature to quickly provide geographic information to a repository, in this instance a directory of coffee shop information. Each of the stores can also be associated with a MURL for subsequent retrieval.
B. “Probe at location X is broken.” This example is also a status information about a geographic marker or geotag. However, if the probes are given additional identification information, such as a probe status, then they can be tracked using the MOLI and MURL approach.

### 5. User to User

The following dialogs illustrate the use of object location identifiers in a user to user—consumer user example:
A. “I am at this restaurant waiting for you. Here's where it is.” This is a form of MURL in that the person directing the recipient to the restaurant name can simply identify the restaurant by name to that recipient. The system will then determine the appropriate identification and location information for use by the recipient.
B. “I can't see you through all the people at this parade. Send me your MURL and I'll come to you.” This is another form of MURL in that one person is asking another person for their MURL and then determining the corresponding current location for that person (even though they or their system are choosing to ignore the other aspects of the underlying object location identifier, namely the “who?” portion).

The following dialogs illustrate the use of object location identifiers in a user to user—consumer user example:
A. “Emergency! Get *here* as fast as you can.”
B. “I'm *here* without the right parts to fix my problem. Is anyone close to me with a spare?”
   OLI/MOLI/MURL with Electronic Document Applications

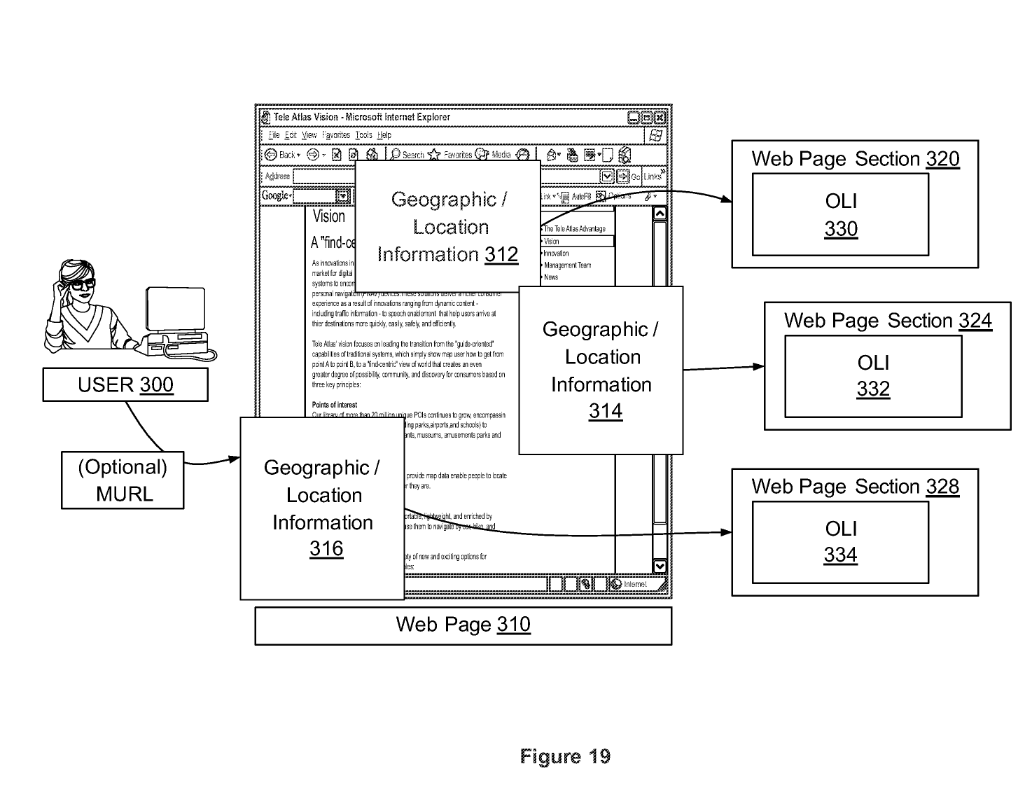

FIG. 19 is an illustration of a system in accordance with an embodiment that uses object location identifiers with a Web page. As shown in FIG. 19, a user or operator 300 can access a Web page 310. All or portions of the Web page can have a single or a plurality of OLI tags or identifiers 312, 314, 316. The OLI tag(s) in the Web page can be used to retrieve an OLI/MOLI 330, 332, 334, and provide additional information, applications, and services to the user. In accordance with a particular embodiment a user can also use a MURL to request information about a particular object.

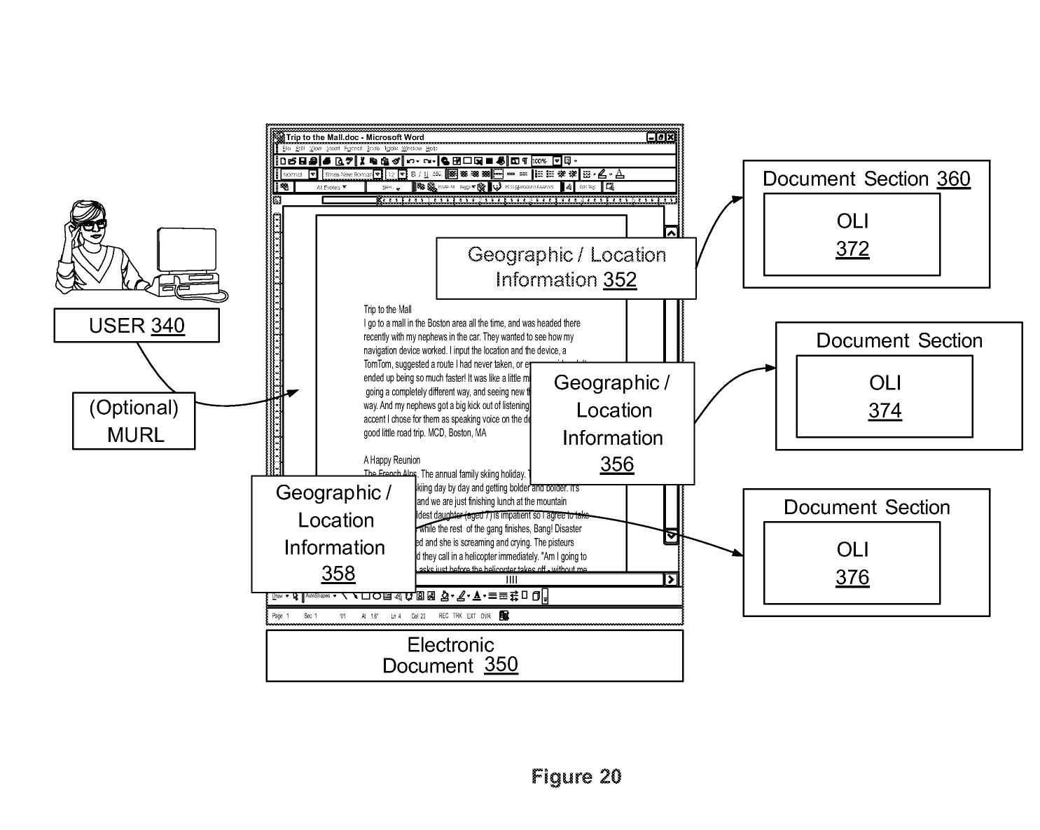

FIG. 20 is an illustration of a system in accordance with an embodiment that uses object location identifiers with an electronic document. As shown in FIG. 20, OLI/MOLI information can be embedded in an electronic document. A user or operator 300 can access the electronic document 350, wherein all or portions of the electronic document can have a single or a plurality of OLI tags or identifiers 352, 356, 358. The OLI tag(s) in the document can be used to retrieve a OLI/MOLI 372, 374, 376, and provide additional information, applications, and services to the user. In accordance with a particular embodiment a user can also use a MURL to request information about a particular object.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method for creating and implementing a geographic marker, comprising:
creating a geographic marker corresponding to a location, wherein said geographic marker comprises a standardized universal code encoding a particular location; and
attaching the geographic marker to an object.

2. The method of claim 1, wherein the attachment of the geographic marker to the object enables spatial connectivity between the object and other objects.

3. The method of claim 1, wherein the attachment of the geographic marker to the object enables spatial connectivity between the object and one or more documents.

4. The method of claim 1, wherein the attachment of the geographic marker to the object enables spatial connectivity between the object and one or more maps.

5. The method of claim 1, wherein the object is comprised in a document, and wherein the attachment of the geographic marker to the object enables spatial connectivity between the document and one or more maps.

6. The method of claim X-1, wherein the attachment of the geographic marker to the object enables spatial connectivity between the document and one or more maps.

7. The method of claim 1, wherein the geographic marker encodes a current location.

8. The method of claim 1, wherein the geographic marker encodes a destination location.

9. The method of claim 1, wherein the geographic marker encodes a desired location.

10. The method of claim 9, wherein the desired location is determined based on one of a projected destination and a known destination of a vehicle that is carrying the object.

11. The method of claim 1, wherein the geographic marker encodes a past location.

12. The method of 10, wherein the geographic marker encodes an origin.

13. The method of claim 1, wherein the geographic marker encodes the address of ownership of the object.

14. The method of claim 1, wherein the object is an electronic object.

15. The method of claim 14, wherein the electronic object is located in one of a file, a database, an electronic mail message, a web page, and another type of electronic document.

16. The method of claim 15, wherein the electronic object is located in an electronic mail message.

17. The method of claim 16, wherein the geographic marker encodes an origin of the message.

18. The method of claim 16, wherein the geographic marker encodes a destination of the message.

19. The method of claim 16, wherein the geographic marker encodes an origin of the message.

20. The method of claim 16, wherein the geographic marker encodes one or more intermediate points traversed by the email message.

21. The method of claim 15, wherein the electronic object is located in a database.

22. The method of claim 21, wherein geographic markers are attached to one of more fields pertaining to one of more items in the database.

23. The method of claim 1, wherein the object is a non-electronic object.

24. The method of claim 1, wherein the geographic marker comprises latitude and longitude.

25. The method of claim 24, wherein the geographic marker further comprises azimuth.

26. The method of claim 1, wherein the geographic marker comprises a universal location referencing code (ULRC).

27. The method of claim 1, wherein the geographic marker uses an organized mapping system between locations and indices, and wherein said geographic marker does not comprise both a latitude and a longitude, and wherein said geographic marker also does not comprise universal location referencing codes (ULRCs).

28. The method of claim 27, wherein said mapping system comprises zip codes.

29. The method of claim 1, wherein the geographic marker or the object comprises a device capable of translating between different marker formats.

30. The method of claim 1, wherein the geographic markers are used to restrict results of a search to objects that correspond to selected locations.

31. The method of claim 1, wherein said object is comprised within one of a palmtop computer, a cellular telephone, and a personal digital assistant (PDA).

32. The method of claim 1, wherein said geographic marker is used to select one or more location-based service, based on user interests and user location.
